(19) United States
(12) Patent Application Publication
(10) Pub. No.: US 2025/0182042 A1
(43) Pub. Date: Jun. 5, 2025

(54) Method and Apparatus for Determining Whether a Piece of Information Authorizes Access to a Compartment of a Compartment System

(71) Applicants: Frank Helferich, Leubsdorf (DE); Frank Reichwald, Troisdorf (DE)

(72) Inventors: Frank Helferich, Leubsdorf (DE); Frank Reichwald, Troisdorf (DE)

(73) Assignee: Deutsche Post AG, Bonn (DE)

(21) Appl. No.: 18/966,691

(22) Filed: Dec. 3, 2024

(30) Foreign Application Priority Data
Dec. 4, 2023 (DE) 10 2023 133 858.7

(51) Int. Cl. G06Q 10/0836

(52) U.S. Cl. CPC G06Q 10/0836

(57) ABSTRACT

A method performed on a first apparatus including obtaining a first piece of information from a second apparatus. The first piece of information is associated with the second apparatus. Authenticating the second apparatus based on at least the first piece of information. Generating a second piece of information. A third apparatus different from the second apparatus or a user of the third apparatus can gain access to one or more compartments of a compartment system using the second piece of information. Outputting the second piece of information. A positive result of the authentication of the second apparatus is a necessary condition for outputting the second piece of information. Three associated methods, one performed on the second apparatus, one on the third apparatus and one on the compartment system in a system having the first, second and third apparatus. Corresponding apparatuses, systems and computer programs for disclosed methods are disclosed.

### CROSS-REFERENCE TO RELATED PATENT APPLICATIONS

This patent application claims the benefit of priority to German Patent Application No. 10 2023 133 858.7, filed Dec. 4, 2023, the entire teachings and disclosures are incorporated herein by reference thereto.

### FIELD

Exemplary embodiments of the invention relate to methods, apparatuses, systems and computer programs for authenticating a user of a compartment system, wherein the compartment system is in particular a compartment system for sending and/or receiving shipments and/or for depositing and/or removing objects, and wherein the compartment system is used and/or managed in particular by multiple companies on a pro-rata basis.

### BACKGROUND

Compartment systems are used in a variety of ways, for example in the form of locker or parcel compartment systems. An example of a parcel compartment system is the applicant's Packstation, to which a recipient can have shipments delivered. The shipment is deposited by the delivery agent in a compartment of a Packstation located near the recipient and/or previously stipulated by the recipient, the compartment is closed and the recipient is notified accordingly. So that the notified recipient can remove a shipment made available for him from a compartment of the compartment system, the compartment system must determine that the recipient is authorized to gain access to one or more compartments of the compartment system.

### SUMMARY OF SOME EXEMPLARY EMBODIMENTS OF THE INVENTION

As far as a compartment system is concerned, it is basically desirable that it can reliably, efficiently, robustly and securely determine that a user is authorized to gain access to one or more compartments of the compartment system in order to subsequently grant access to the corresponding compartments.

In addition, flexible use of a compartment system is desirable, so that not only the operator, who manages a plurality of compartment systems, but also partner companies with different apparatuses or systems, e.g. different delivery services, online dealers or local service providers (e.g. tradesmen), can allow access to compartments of a compartment system. For example, compartments can be rented over the long term to the partner company, which then decides independently on the use of the compartments. The technical management of its compartments, whether and what deliveries are deposited in them and who is authorized to open the compartments, can thus be carried out by the partner company, i.e. their technical systems. The technical systems of the operator may be limited to the provision of the compartments and the authentication process for opening a compartment. For example, there is no distinction between whether the compartment is opened for depositing a delivery by delivery services or end customers or for removal or checking.

With regard to security, it is particularly relevant to prevent unauthorized access to compartments of the compartment system. In the event that unauthorized access to a compartment of the compartment system has nevertheless occurred, it is also relevant to determine at which point in the system, i.e. in whose area of responsibility, for example, there was a security leak. If, for example, compromised access data were used during unauthorized access, it is relevant to determine in which system or part of a system the access data could be spied on. This is especially true if different apparatuses or systems can generate access data for compartments of a compartment system.

With regard to data protection, it is particularly relevant that personal data are stored in as few places as possible in the system. With regard to use by partner companies, it is desirable that as little information as possible that is relevant to data protection need also be stored in the system of the compartment system in addition to the system of the partner company or exchanged between them. In addition, with regard to flexible use, it is desirable for partner companies with different business models to be able to decide for themselves on the degree of security of the overall system.

The object of the present invention is to overcome one or more of the disadvantages described above and/or to obtain one or more of the advantages described above and/or to achieve one or more of the desired improvements described above.

According to a first exemplary aspect of the invention, a method is disclosed, which is performed, for example, by a first apparatus (e.g. a server of the applicant), the method comprising: obtaining a first piece of information from a second apparatus, wherein the first piece of information is associated with the second apparatus; authenticating the second apparatus based on at least the first piece of information; generating a second piece of information, wherein a third apparatus different from the second apparatus or a user of the third apparatus can gain access to one or more compartments of a compartment system using the second piece of information; and outputting the second piece of information, wherein a positive result of the authentication of the second apparatus is a necessary condition for outputting the second piece of information.

According to a second exemplary aspect of the invention, a method is disclosed, which is performed, for example, by a second apparatus (e.g. a server of a partner wishing to allow its customer access to a compartment of a compartment system), the method comprising: obtaining a third piece of information from a third apparatus; generating a first piece of information, wherein the first piece of information is associated with the second apparatus; and outputting the first piece of information to a first apparatus in order to allow the first apparatus to authenticate the second apparatus based on at least the first piece of information, wherein a positive result of the authentication is a necessary condition for outputting a second piece of information from the first apparatus, wherein a third apparatus or a user of the third apparatus can gain access to one or more compartments of a compartment system using the second piece of information, and wherein obtaining the third piece of information is a necessary condition for outputting the first piece of information.

According to a third exemplary aspect of the invention, a method is disclosed, which is performed, for example, by a third apparatus (e.g. a mobile apparatus), the method comprising: obtaining a third piece of information from a compartment system or generating a third piece of information; and outputting the third piece of information to a second apparatus, wherein obtaining the third piece of information by the second apparatus is a necessary condition for outputting a first piece of information to a first apparatus by the second apparatus, wherein a positive result of the authentication of the second apparatus by the first apparatus based at least on the first piece of information is a necessary condition for outputting a second piece of information by the first apparatus, wherein the third apparatus or a user of the third apparatus can gain access to one or more compartments of a compartment system using the second piece of information.

According to a fourth exemplary aspect of the invention, a method is disclosed, which is performed, for example, by a compartment system in a system having an apparatus according to the first aspect of the invention, an apparatus according to the second aspect of the invention and an apparatus according to the third aspect of the invention, the method comprising: obtaining the second piece of information; and determining whether access to one or more compartments of the compartment system can be granted based on the second piece of information.

In terms of terminology, a “first apparatus”, a “second apparatus” and a “third apparatus” can each be any apparatus. However, a “first apparatus” may also be, for example, an apparatus according to the first aspect of the invention. A “second apparatus” may be, for example, an apparatus according to the second aspect of the invention. A “third apparatus” may also be, for example, an apparatus according to the third aspect of the invention. In addition, for example, the “first apparatus” mentioned in the methods according to various aspects of the invention may be the same apparatus across the methods. Similarly, for example, the “second apparatus” in the methods according to various aspects of the invention may be the same apparatus. Likewise, the “third apparatus” in the methods according to various aspects of the invention may be the same apparatus.

The same applies to the “first piece of information”, which can be the same piece of information across methods, for example, the “second piece of information”, which can be the same piece of information across methods, and the “third piece of information”, which can be the same piece of information across methods.

The present application further discloses for each of the four aspects of the invention:

A computer program comprising program instructions which cause a processor to perform and/or control an exemplary embodiment of the method according to the invention of the respective aspect of the invention when the computer program is running on the processor. A processor in this specification shall be understand as meaning, inter alia, control units, microprocessors, microcontrol units such as microcontrollers, digital signal processors (DSP), application-specific integrated circuits (ASICs) or field programmable gate arrays (FPGAs). Either all steps of the method can be controlled or all steps of the method can be performed, or one or more steps can be controlled and one or more steps can be performed. The computer program can be distributable, for example, via a network such as the Internet, a telephone or mobile radio network, and/or a local area network. The computer program can be at least partially software and/or firmware of a processor. It can also be implemented at least partially as hardware. The computer program may be stored, for example, on a computer-readable storage medium, e.g. a magnetic, electrical, optical and/or other storage medium. For example, the storage medium may be part of the processor, such as a (non-volatile or volatile) program memory of the processor or a part of it. For example, the storage medium may be a substantive or physical storage medium. At least one such processor is integrated in each case in the backend system, in each compartment system and in each mobile device.

An apparatus or a system comprising at least more than one apparatus, wherein the apparatus or the system is configured to perform and/or control the exemplary embodiment of the respective aspect of the method according to the invention or comprising respective means for performing and/or controlling the steps of the exemplary embodiment of the aspect of the method according to the invention. Either all steps of the method can be controlled or all steps of the method can be performed, or one or more steps can be controlled and one or more steps can be performed. One or more of the means can also be implemented and/or controlled by the same unit. For example, one or more of the means may be formed by one or more processors.

An apparatus comprising at least one processor and at least one memory comprising program code, wherein the memory and the program code are configured to cause an apparatus having the at least one processor to perform and/or control at least the exemplary embodiment of the respective aspect of the method according to the invention. Either all steps of the method can be controlled or all steps of the method can be performed, or one or more steps can be controlled and one or more steps can be performed.

Further advantageous exemplary configurations of the invention can be gathered from the following detailed description of some exemplary embodiments of the present invention, in particular in conjunction with the figures. However, the figures accompanying the application are intended to serve only the purpose of clarification, but not to determine the scope of protection of the invention. The accompanying drawings are not necessarily true to scale and are merely intended to reflect the general concept of the invention by way of example. In particular, features contained in the figures are in no way intended to be regarded as a necessary part of the present invention.

### BRIEF DESCRIPTION OF THE DRAWINGS

In the drawings:

FIG. 1 shows a schematic representation of an exemplary embodiment of a system according to the present invention;

FIG. 2 shows a flowchart of an exemplary embodiment of a method according to the first aspect of the present invention;

FIG. 3 shows a flowchart of an exemplary embodiment of a method according to the second aspect of the present invention;

FIG. 4 shows a flowchart of an exemplary embodiment of a method according to the third aspect of the present invention;

FIG. 5 shows a flowchart of an exemplary embodiment of a method according to the fourth aspect of the present invention;

FIG. 6a and FIG. 6b show a schematic representation of exemplary data transmissions between apparatuses, each performing exemplary embodiments of methods according to a respective aspect of the invention;

FIG. 7a and FIG. 7b show a schematic representation of exemplary data transmissions between apparatuses, each performing exemplary embodiments of methods according to a respective aspect of the invention;

FIG. 8 shows a schematic representation of an exemplary embodiment of an apparatus according to the first or second aspect of the present invention;

FIG. 9 shows a schematic representation of an exemplary embodiment of an apparatus according to the fourth aspect of the present invention; and

FIG. 10 shows a schematic representation of an exemplary embodiment of an apparatus according to the third aspect of the present invention.

### DETAILED DESCRIPTION OF SOME EXEMPLARY EMBODIMENTS OF THE INVENTION

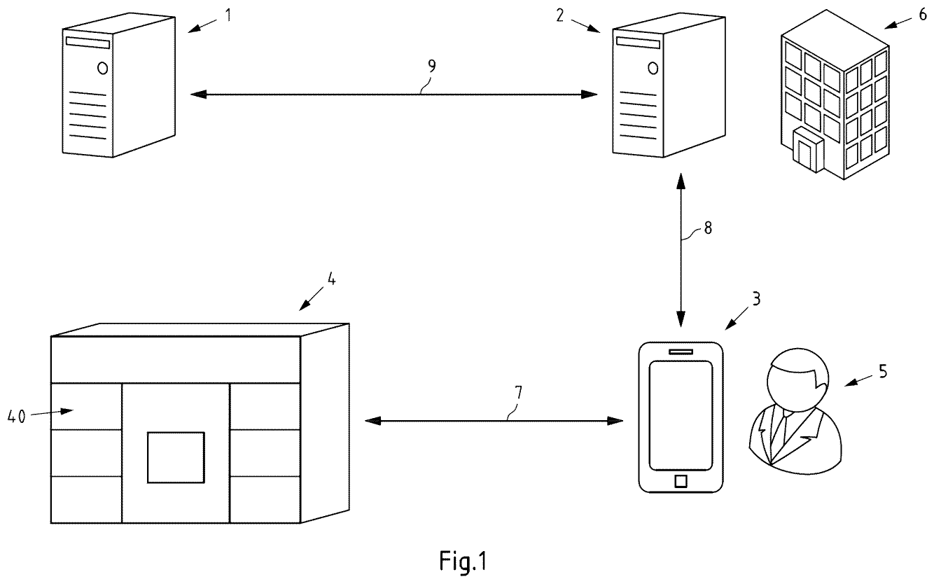

FIG. 1 schematically shows a system according to an exemplary embodiment of the present invention.

The system comprises a compartment system 4 having a plurality of compartments, one compartment of which is provided with reference sign 40 in FIG. 1. Each of the compartments of the compartment system 4 is provided for holding one or more shipments and/or one or more objects, e.g. for an individual user or a group of users. Multiple compartments can also be assigned to an individual user or a group of users. Each compartment is locked or closed in the basic state and can be electrically unlocked or opened individually and in a manner controlled by instructions, for example by a lock control unit provided in the compartment system 4. An example of such a compartment system 4 is a compartment system according to the known Packstation concept of the applicant.

The compartment system 4 is equipped with one or more communication interface(s) comprising, for example, an interface for wireless communication with a mobile device 3, for example by means of optical transmission and/or by means of communication based on electrical, magnetic or electromagnetic signals or fields, in particular close-range communication, e.g. based on optical transmission, Bluetooth, Wireless Local Area Network (WLAN), ZigBee, Near Field Communication (NFC), Infrared Data Association (IrDA) and/or Radio-Frequency Identification (RFID). Preferably, the mobile device 3 of the user 5 assumes the function of a user interface for the compartment system 4, with the result that the compartment system 4 can be designed particularly simply. The compartment system 4 is then operated, for example, by the mobile device 3, in particular by an app that is installed thereon and communicates with the partner server 2 and/or in the form of a relay allows the data exchange between the compartment system 4 and the partner server 2 and/or indirectly between the compartment system 4 and the backend system 1. For this purpose, the compartment system 4 communicates with the mobile device 3 via a close-range data communication connection 7 (e.g. Bluetooth, NFC, RFID, WLAN, ZigBee, IrDA, QR codes, etc.) and then in particular must not be able to set up a remote data communication connection (e.g. a cellular mobile radio connection) to the backend system 1 and/or the partner server 2, since this functionality is provided by the mobile device 3.

A second apparatus 2, which in this exemplary embodiment is, for example, a partner server 2, is operated by a partner 6 having and itself managing a compartment allocation of one or more compartments of a compartment system 4. It manages which users 5 should be granted access to which compartment or compartments 40, that is/are locked in the basic state, of the compartments of the compartment system 4 that are managed by it. Users 5 can be understood as meaning, for example, persons using the compartment system 4 to receive and/or send shipments (e.g. parcels, letters, etc.) and/or to deposit and/or remove objects (e.g. meals, food, laundry, keys, etc.), as well as delivery agents delivering such shipments and/or deliveries of objects to the compartment system 4 or collecting them from the compartment system 4. A user 5 can be a human or a machine, such as a vehicle, a robot or a drone, to name just a few examples.

In order to gain access to one or more compartments 40 of the compartment system 4, the user 5 must transmit a piece of information to the partner server 2 by using a third, preferably mobile apparatus 3. In this exemplary embodiment, the third apparatus 3 is, by way of example, a mobile device 3 (which can be, for example, a mobile telephone, in particular a smartphone, or a handheld scanner of a delivery agent). For example, an app, that is to say a complex program, which the user 5 installed on the mobile device 3 at an earlier time, for example on the occasion of his registration for the use of the partner server 2, or was installed for the user 5, is executed on the mobile device 3, for example a smartphone. The mobile device 3 is designed here by way of example to establish a close-range data communication connection 7, for example optical transmission, Bluetooth, ZigBee, NFC, RFID, WLAN or IrDA, to the compartment system 4 or its communication interface and to establish a remote data communication connection 8, for example via a data communication connection of a cellular mobile radio system, to the partner server 2 or its communication interface, as illustrated in FIG. 1 by respective arrows. For example, the communication between the mobile device 3 and the partner server 2 is based on the Internet Protocol (IP), in which case the partner server 2 is reachable via the Internet, and the mobile device 3 accesses the Internet via a wireless radio connection (e.g. a cellular mobile radio connection). The communication between the mobile device 3 and the partner server 2 can be partially or fully encrypted. An app or a program that controls the communication with the compartment system 4, the user 5 as well as with the partner server 2 and is provided, for example, by the partner 6 can be installed on the mobile device 3. This allows the user 5 to use, for example, a commercially available smartphone as the mobile device 3, on which then only such an app has to be installed and—for example by registering in the partner server 2—put into operation.

A first apparatus 1, which in this exemplary embodiment is a backend system 1 for example, centrally manages which partner 6 should be granted access to which compartment or compartments 40 (locked in the basic state) of the compartment system 4. Partners can be understood as meaning, for example, contractual or interface partners who, for example, manage specific compartments of the compartment system 4 themselves and make them available to users in a long-term contract. The communication between the partner server 2 and the backend system 1 is carried out here, for example, by means of remote data communication 9, for example via an interface to a cellular mobile radio system, a Digital Subscriber Line (DSL) interface or a Local Area Network (LAN) interface. Alternatively, the backend system 1 and the partner server 2 can be located locally close to each other and can communicate with each other using a local connection (e.g. via a Local Area Network).

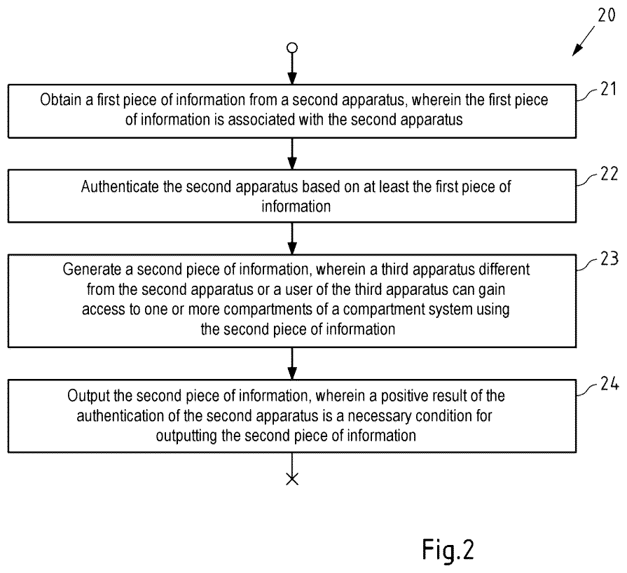

FIG. 2 shows a flowchart 20 of an exemplary embodiment of a method according to the first aspect of the present invention, for example performed and/or controlled by a first apparatus. The first apparatus is, for example, the backend system 1 from FIG. 1.

In step 21, a first piece of information is obtained from a second apparatus, wherein the first piece of information is associated with the second apparatus. In step 22, the second apparatus is authenticated based on at least the first piece of information. In step 23, a second piece of information is generated, wherein a third apparatus different from the second apparatus or a user of the third apparatus can gain access to one or more compartments of a compartment system 4 using the second piece of information. In step 24, the second piece of information is output, wherein a positive result of the authentication of the second apparatus is a necessary condition for outputting the second piece of information. The second piece of information can be output, for example, to the second apparatus or, in embodiments with a direct data connection between the first apparatus and the compartment system 4, can be output directly to the compartment system 4.

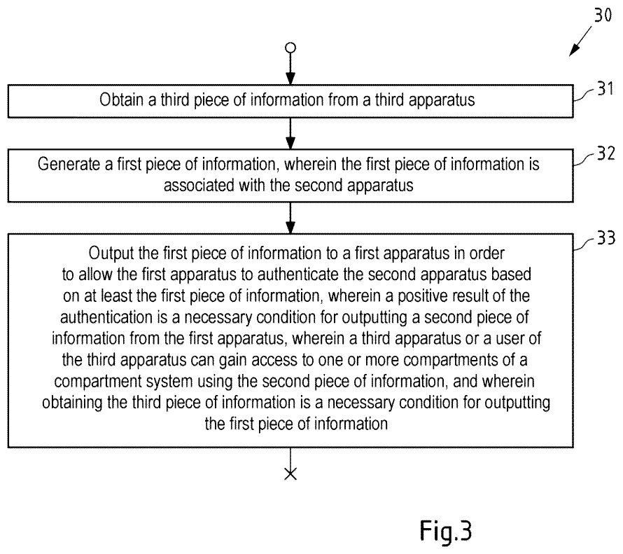

FIG. 3 shows a flowchart 30 of an exemplary embodiment of a method according to the second aspect of the present invention, for example performed and/or controlled by a second apparatus. The second apparatus is, for example, the partner server 2 from FIG. 1.

In step 31, a third piece of information is obtained from a third apparatus. In step 32, a first piece of information is generated, wherein the first piece of information is associated with the second apparatus. For example, the generation can be done in response to step 31. However, the generation can also be done independently of obtaining the first piece of information; in particular, the first piece of information may have been generated and stored, for example, in the partner server 2 before obtaining the first piece of information. In step 33, the first piece of information is output to a first apparatus in order to allow the first apparatus to authenticate the second apparatus based on at least the first piece of information, wherein a positive result of the authentication is a necessary condition for outputting a second piece of information from the first apparatus, wherein a third apparatus or a user of the third apparatus can gain access to one or more compartments 40 of a compartment system 4 using the second piece of information, and wherein obtaining the third piece of information is a necessary condition for outputting the first piece of information. The output corresponds to obtaining the first piece of information in step 21 of the flowchart 2.

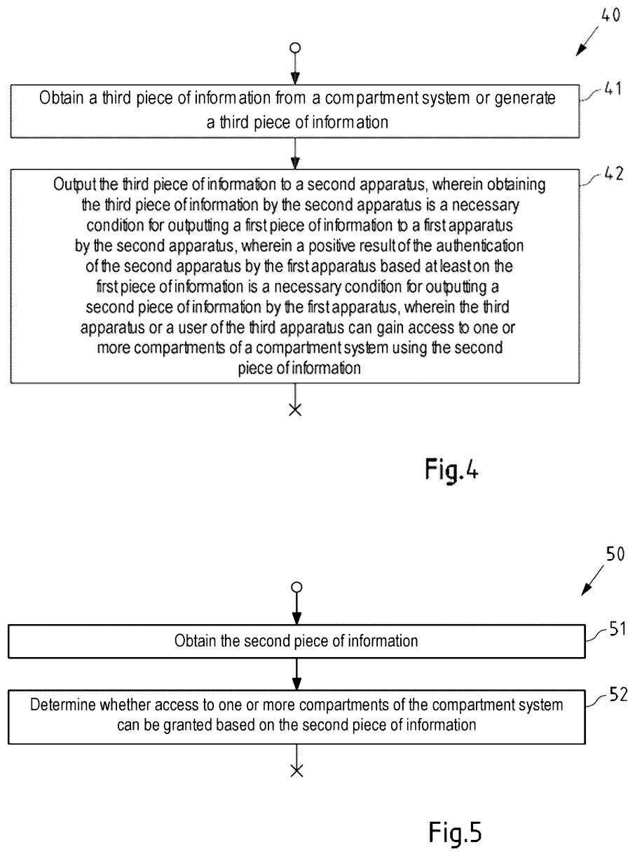

FIG. 4 shows a flowchart 40 of an exemplary embodiment of a method according to the third aspect of the present invention, for example performed and/or controlled by a third apparatus. The third apparatus is, for example, the mobile device 3 from FIG. 1. In other embodiments, the third apparatus may be, for example, a handheld scanner of a supplier.

In step 41, a third piece of information is generated or obtained from a compartment system 4. In step 42, the third piece of information is output to a second apparatus, wherein obtaining the third piece of information by the second apparatus is a necessary condition for outputting a first piece of information to a first apparatus by the second apparatus, wherein a positive result of the authentication of the second apparatus by the first apparatus based at least on the first piece of information is a necessary condition for outputting a second piece of information by the first apparatus, wherein the third apparatus or a user of the third apparatus can gain access to one or more compartments 40 of a compartment system 4 using the second piece of information. The output corresponds to obtaining the third piece of information in step 31 of the flowchart 3.

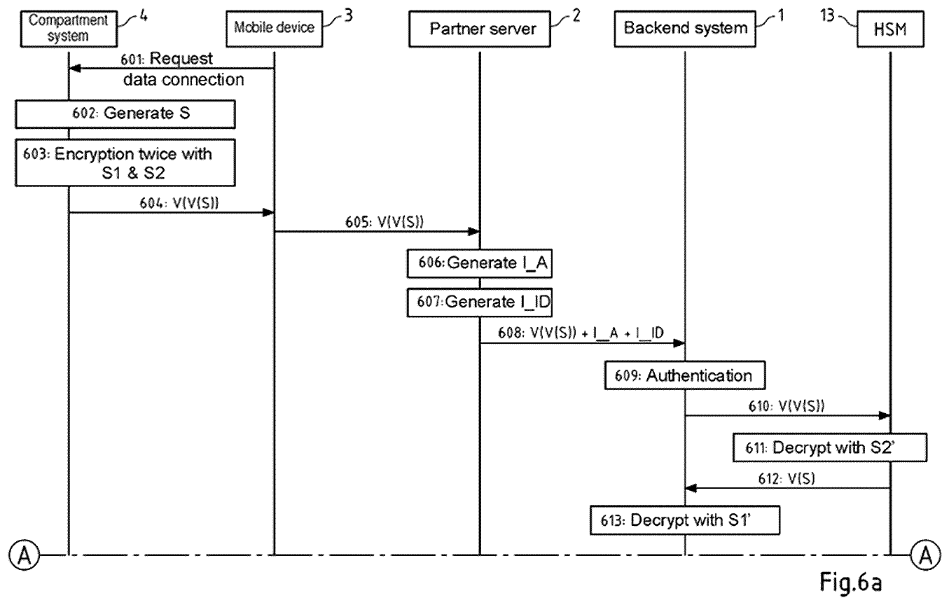

FIG. 5 shows a flowchart 50 of an exemplary embodiment of a method according to the fourth aspect of the present invention, for example performed and/or controlled by a compartment system 4 in a system having an apparatus according to the first aspect of the invention, an apparatus according to the second aspect of the invention and an apparatus according to the third aspect of the invention.

The second piece of information is obtained in step 51. The second piece of information can be obtained, for example, from the third apparatus or, in embodiments with a direct data connection between the first apparatus and the compartment system 4, can be obtained directly from the first apparatus. In step 52, it is determined whether access to one or more compartments of the compartment system 4 can be granted based on the second piece of information. Determining that access to one or more compartments of the compartment system 4 can be granted based on the second piece of information is based, for example, on successful decryption of the second piece of information or on the verification of a signature of the first apparatus by the compartment system.

In order to gain access to one or more compartments 40 of the compartment system 4, the user 5 must submit an access request to the partner server 2. For this purpose (FIG. 4, step 42), the user 5 transmits an initial message to the partner server 2 using the mobile device 3. The initial message is, for example, the third piece of information according to the second or third aspect of the invention. The initial message may have been generated by the compartment system 4 and transmitted to the mobile device 3 via the close-range data communication connection 7 or may be generated by the mobile device 3 itself (FIG. 4, step 41).

In order to enable a user 5 to access one or more compartments 40 of the compartment system 4 as requested after receiving the initial message (FIG. 3, step 31), the partner 6 must first be authenticated with respect to the backend system 1. For this purpose, the partner 6 must first transmit a previously generated first piece of information (FIG. 3, step 32) to the backend system 1 via the partner server 2 (FIG. 3, step 33). The first piece of information must contain at least one piece of information associated with the partner server 2, for example a piece of authentication information. The piece of authentication information can be, for example, a permanently assigned partner identifier, a digital signature or a partner identifier/password combination (i.e. a combination of partner identifier and associated password). In addition, the first piece of information may contain, for example, pieces of information on one or more compartments 40 of the compartment system 4, for which the partner 6 would like to grant access to the user 5.

The backend system 1 is formed by at least one server device. Respective pieces of authentication information that are assigned to registered partners 6 and are at least partially static or variable over time are stored in the backend system 1. After obtaining the first piece of information (FIG. 2, step 21), the backend system 1 performs a process for authenticating the partner 6 (FIG. 2, step 22) by comparing the pieces of authentication information provided by the partner server 2 with the pieces of authentication information stored for this partner 6. The partner server 2 is positively authenticated only on condition that the validity of the piece(s) of authentication information provided during authentication has been verified and confirmed. For example, the partner server 2 is positively or successfully authenticated only if the piece of authentication information provided by the partner server 2 matches or corresponds to a piece of authentication information stored for this partner 6 or can be mapped to it by means of a predetermined transformation. Otherwise, if the pieces of authentication information provided by the partner server 2 have been assessed as invalid during verification, the authentication is ended unsuccessfully or with a negative result. The result of the (fully performed) process for authenticating the partner server 2 is such that the partner server 2 is either authenticated—in the case of authentication with a positive result—or not authenticated—in the case without authentication of the partner server 2 or in the case of a negative result. In the case of a positive result, the backend system 1 generates a second piece of information (FIG. 2, step 23) containing, for example, an opening instruction for unlocking or opening one or more compartments 40 of the compartment system 4, and outputs it (FIG. 2, step 24). After obtaining the second piece of information (FIG. 5, step 51), the compartment system checks whether the pieces of information obtained authorize access to one or more compartments 40 (FIG. 5, step 52), and opens the compartment or compartments 40 in the case of a positive checking result, so that the user 5 is granted access.

Flexible use of the compartment system 4 is made possible by separating the access request from the user 5 to the partner server 2 on the one hand and the authentication of the partner 6 with respect to the backend system 1 on the other hand. For example, the operator of the compartment system 4 is neither technically nor procedurally involved in the user processes of the partner 6. This is particularly advantageous for the operator of the backend system 1 and the compartment system 4, since, for example, no special data and/or user interfaces for the individual users 5 must be provided by one or more different partners 6 in the backend system 1. In addition, there are only minor responsibilities of the operator, for example with regard to data protection, liability and/or customer service issues. For the partner 6, there is the advantage, for example, of being able to itself confidently design the registration, log-in and/or collection processes of the user 5, as well as, for example, a relevant app on the mobile device 3 of the user 5. This is particularly advantageous, since different partners 6 can thus implement different business models and adapt their processes to these business models and, for example, associated legal requirements. For example, the sending/receiving of food, meals or laundry, for example, is subject to different legal requirements in comparison with parcels or letters, for example, e.g. with regard to data protection (e.g. postal secrecy), and so registration of the user 5 may be absolutely necessary for parcels, for example, whereas it could be dispensed with for food. The user 5 has the advantage that, for example, he only needs to have the app of the partner 6, whose service he wishes to use by using the compartment system 4, installed on his mobile device. However, an additional app of the operator of the compartment system 4 or the backend system 1, a registration with the operator of the compartment system 4 or the backend system 1 and/or an identification/authentication of the user 5 with respect to the backend system 1 is not necessary.

According to the embodiment illustrated in FIG. 1, there is preferably no direct data communication connection between the backend system 1 and the compartment system 4, but rather these can only communicate with each other by forwarding data via the partner server 2 and the mobile device 3. Thus, the compartment system 4 advantageously need not have a remote data communication interface, for example a LAN interface and/or mobile radio interface, and can therefore advantageously also be installed at remote locations. For this purpose, in the embodiment illustrated in FIG. 1, the instruction from the backend system 1 to the compartment system 4 is first transmitted via the remote data communication connection 9 to the partner server 2, is then transmitted via the remote data communication connection 8 from the partner server 2 to the mobile device 3 and is then transmitted from the mobile device 3 to the compartment system 4 via the close-range data communication connection 7.

For this purpose, the method 30 in exemplary embodiments according to the second aspect of the invention further comprises obtaining the second piece of information from the first apparatus, the backend system 1 in this exemplary embodiment, and outputting the second piece of information to the third apparatus, the mobile device 3 in this exemplary embodiment, and the method 40 in exemplary embodiments according to the third aspect of the invention further comprises obtaining the second piece of information from the second apparatus, the partner server 2 in this exemplary embodiment, and outputting the second piece of information to the compartment system 4. In other embodiments, the second piece of information can also be transmitted via a direct data communication connection between the backend system 1 and the compartment system 4.

In exemplary embodiments of the fourth aspect of the invention, the method 50 may further involve generating the third piece of information and outputting the third piece of information to the third apparatus 3, the mobile device 3 in this exemplary embodiment. The third piece of information is generated, for example, by the compartment system 4. The third piece of information may include, for example, a compartment system identifier, a time stamp, a counter and/or indexes for various protocol sequences. This may be advantageous, for example, if the partner 6 manages multiple compartment systems 4, so that the partner server 2 can determine which compartment system 4 the user 5 is in front of, without the user 5 having to actively generate pieces of information for the partner server 2.

In exemplary embodiments of the second aspect of the invention, the method 30 may further comprise outputting the third piece of information to the first apparatus 1, the backend system 1 in this exemplary embodiment, wherein the third piece of information is associated with the compartment system 4. In exemplary embodiments of the first aspect of the invention, the method 20 may further comprise obtaining the third piece of information from the second apparatus 2, the partner server 2 in this exemplary embodiment, wherein the third piece of information is associated with the compartment system 4. As already explained, the third piece of information may include, for example, a compartment system identifier, a time stamp, a counter and/or indexes for various protocol sequences. The association of the third piece of information of a compartment system 4 is already given, for example, by the fact that the third piece of information was generated by the compartment system 4. However, the association may also be given by an assignability of the third piece of information to a compartment system 4 or one or more compartments 40 of the compartment system 4. The transmission of the third piece of information to the first apparatus 1 may be advantageous, for example, in embodiments in which the authentication of the second apparatus 2 by the first apparatus 1 (FIG. 2, step 22) is further based on the third piece of information. For example, the backend system 1 manages multiple compartment systems 4, the partner 6 of which is not authorized for all compartment systems 4, and so the result of the authentication of the partner 6 depends on the compartment system 4 or the compartment/compartments 40 of the compartment system 4, to which access is intended to be granted. If the third piece of information contains pieces of information on protocol sequences, transmission of the third piece of information from the partner server 2 to the backend system 1 may be advantageous, if, for example, different protocol versions or different encryption methods for data communication between the backend system 1 and the compartment system 4 exist. In addition, in some of these exemplary embodiments, the authentication of the second apparatus 2 by the first apparatus 1 (FIG. 2, step 22) may further be based on the third piece of information. For example, the third piece of information is advantageously generated only by the compartment system 4 if the mobile device 3 is located at the location (in particular at the present location) of the (for example stationary) compartment system 4. This can be done, for example, by a proximity test on the basis of a wireless and/or wired connection, near-field coupling, for example inductive or capacitive coupling, a radio connection or the close-range data communication connection 8 between the compartment system 4 and the mobile device 3. Thus, advantageously, access to one or more compartments 40 of the compartment system 4 is only granted when the user 5 is at the compartment system 4.

In exemplary embodiments according to the second aspect of the invention, the method may further comprise generating a fourth piece of information and outputting the generated fourth piece of information to a first apparatus 1, the backend system 1 in this exemplary embodiment, wherein the fourth piece of information is associated with the third apparatus 3, the mobile device 3 in this exemplary embodiment, and wherein, after obtaining the fourth piece of information by the first apparatus 1, at least a piece of information that is transmitted between the first apparatus 1 and the second apparatus 2, the partner server 2 in this exemplary embodiment, is based at least on the fourth piece of information. The fourth piece of information is generated, for example, by the partner server 2 at the time at which the third piece of information is obtained from the mobile device 3.

In exemplary embodiments of the method according to the invention according to the first aspect, the method 20 may also comprise obtaining a fourth piece of information from the second apparatus 2, the partner server 2 in this exemplary embodiment, wherein the fourth piece of information is associated with the third apparatus 3, the mobile device 3 in this exemplary embodiment, and wherein, after obtaining the fourth piece of information by the first apparatus 1, at least a piece of information that is transmitted between the first apparatus 1, the backend system 1 in this exemplary embodiment, and the second apparatus 2 is based at least on the fourth piece of information. For example, the reception is carried out by the backend system 1. For example, the fourth piece of information contains an internal (in particular unique) session number (session ID) of the partner server 2. The association of the fourth piece of information with the mobile device 3 is given, for example, by the fact that the fourth piece of information is generated by the partner server 2 when the third piece of information is obtained from the mobile device 3. However, the association can also be given by an assignability of the fourth piece of information to the mobile device 3 in the partner server 2. The session ID is preferably transmitted from the partner server 2 to the backend system 1 via a remote data communication connection 9. The session ID is used to assign the data exchanged between the backend system 1 and the partner server 2 and is contained in the transmitted pieces of information in a subsequent data exchange. This allows, for example, multiple sessions between the backend system 1 and the partner server 2 to be maintained in parallel for different users 5 and pieces of information to be uniquely assigned to a session.

In exemplary embodiments according to the second aspect of the invention, the method 40 may further comprise generating a fifth piece of information and outputting the generated fifth piece of information to the first apparatus 1, the backend system 1 in this exemplary embodiment, wherein obtaining the fifth piece of information is a further necessary condition for outputting the second piece of information (FIG. 2, step 24) by the first apparatus 1. The fifth piece of information is generated, for example, by the partner server 2 and is generated, for example, at the time or in the event of the user 5 having been positively authenticated with the partner server 2 using his mobile device 3 and being authorized to access one or more compartments 40 of the compartment system 4 which is/are managed by the partner server 2. Alternatively, the generation can also already take place, for example, when the third piece of information is obtained. The fifth piece of information is, for example, an opening request which contains, for example, the compartment system identifier and the compartment number(s) for which the user 5 is intended to gain access. The sixth piece of information is preferably output from the partner server 2 to the backend system 1 via a remote data communication connection 9.

Accordingly, in exemplary embodiments according to the first aspect of the invention, the method 20 may also comprise obtaining the fifth piece of information from the second apparatus 2, the partner server 2 in this exemplary embodiment, wherein obtaining the fifth piece of information is a further necessary condition for outputting the second piece of information (FIG. 2, step 24). The obtaining is carried out, for example, by the backend system 1. As already explained, the fifth piece of information is, for example, an opening request and may contain, for example, the compartment system identifier and the compartment number(s) for which the user 5 is intended to gain access. If the result of the authentication of the partner server 2 with respect to the backend system 1 (FIG. 2, step 22), as already explained above, is positive and the opening request is classified as plausible, the backend system 1 generates the second piece of information (FIG. 2, step 23) containing an opening instruction for unlocking or opening one or more compartments 40 of the compartment system 4, and transmits this second piece of information to the compartment system 4, as already explained above. An opening request is classified as plausible, for example, if the partner 6 is authorized for the compartments 40 of the compartment systems 4 specified in the opening request by the included compartment system identifier and the compartment number(s).

In exemplary embodiments according to the first aspect of the invention, the method 20 may further comprise generating a sixth piece of information and outputting the sixth piece of information to the second apparatus 2, the partner server 2 in this exemplary embodiment, wherein the sixth piece of information is based on a result of the process for authenticating the second apparatus 2 (FIG. 2, step 22). The sixth piece of information may include, for example, the result of the authentication check (FIG. 2, step 22). The sixth piece of information is generated, for example, by the backend system 1 and is generated, for example, at the time or in the event of the result of this authentication of the partner 6 with respect to the backend system 1 being certain. The sixth piece of information is transmitted, for example, from the backend system 1 to the partner server 2 via a remote data communication connection 9.

Accordingly, in exemplary embodiments according to the second aspect of the invention, the method 30 may also comprise obtaining the sixth piece of information from the first apparatus 1, the backend system 1 in this exemplary embodiment, wherein the sixth piece of information is based on a result of the authentication of the second apparatus 2 (FIG. 2, step 22), the partner server 2 in this exemplary embodiment. The obtaining is carried out, for example, by the partner server 2. As explained, the sixth piece of information may include, for example, the result of the authentication check (FIG. 2, step 22). If the result of this authentication check included in the sixth piece of information is positive, the fifth piece of information is output to the backend system 1 as described above. If the result is negative or, for example, no result has been obtained, the fifth piece of information is not output and the partner server 2, for example, denies the user 5 access to the compartment. The separate transmission of the first and the fifth piece of information from the partner server 2 to the backend system 1 and the necessary condition of positive authentication (FIG. 2, step 22) for outputting the fifth piece of information may be advantageous, since the partner server 2 can use the obtained piece of information about the result of this authentication check to check whether the user 5 is authorized to access one or more compartments 40 of the compartment system 4. For example, the partner server 2 can determine that the user 5 is located in the vicinity of the compartment system 4 to which the user 5 would like to gain access, if a positive result of the authentication is based on a proximity test as explained in the section above.

In exemplary embodiments according to all aspects of the invention, the second piece of information may be encrypted with a key S, wherein the key S is stored in the compartment system 4, wherein the key S is not known to the second apparatus 2 and to the third apparatus 3, the partner server 2 and the mobile device 3 in this exemplary embodiment. The second piece of information is encrypted, for example, by the backend system 1. In exemplary embodiments according to the first aspect of the invention, in which the second piece of information is encrypted with a key S, the method 20 may further comprise obtaining the key S for encrypted communication with the compartment system 4. The key S is obtained, for example, by the backend system 1. The key S is provided as the key value for data communication between the backend system 1 and the compartment system 4 with forwarding by the mobile device 3 and the partner server 2, i.e. for end-to-end encryption between the backend system 1 and the compartment system 4. For this end-to-end encryption of the unidirectional or bidirectional data communication between the backend system 1 and the compartment system 4, use is preferably made of symmetric encryption in which the backend system 1 and the compartment system 4 encrypt and decrypt the messages with the key S. For example, the Advanced Encryption Standard (AES) with an exemplary key length of 256 bits is used as a method for symmetric encryption. Data communication with the end-to-end encryption between the backend system 1 and the compartment system 4 is preferably carried out with forwarding via the mobile device 3, which receives data from the partner server 2 under the control of an app executed on the mobile device 3 and transmits these data to the compartment system 4 and/or receives data from the compartment system 4 and transmits said data to the partner server 2, and the partner server 2, which receives data from the backend system 1 and transmits these data to the mobile device 3 and/or receives data from the mobile device 3 and transmits these data to the backend system 1. The end-to-end encryption between the backend system 1 and the compartment system 4 and the mere forwarding of the encrypted messages via the partner server 2 and the mobile device 3 ensure the integrity, confidentiality and binding nature of the messages exchanged between the backend system 1 and the compartment system 4 even if the close-range data communication connection 7 between the compartment system 4 and the mobile device 3, the app executed on the mobile device 3, the mobile device 3, the remote data communication connection 8 between the mobile device 3 and the partner server 2, the partner server 2 and/or the remote data communication connection 9 between the partner server 2 and the backend system 1 have been tampered with by an attacker.

In exemplary embodiments according to the fourth aspect of the invention, in which the second piece of information is encrypted with the key S, the method 50 may further comprise generating a seventh piece of information that is encrypted with the key S and outputting the seventh piece of information, wherein, after the first apparatus 1, the backend system 1 in this exemplary embodiment, obtains the seventh piece of information, the first apparatus 1 generates an eighth piece of information based at least on the decrypted seventh piece of information and outputs the eighth piece of information to the second apparatus 2, the partner server 2 in this exemplary embodiment. The seventh piece of information is generated, for example, by the compartment system 4 and contains, for example, pieces of status information relating to the compartment system 4, for example about the opening and/or the subsequent closing of one or more compartments 40 of the compartment system 4. The seventh piece of information is transmitted, for example, from the compartment system 4 to the mobile device 3 via a close-range data communication connection 7, from the mobile device 3 to the partner server 2 via a remote data communication connection 8 and then from the partner server 2 to the backend system 1 via a remote data communication connection 9, for example via a cellular mobile radio network.

For this purpose, in exemplary embodiments according to the third aspect of the invention, in which the second piece of information is encrypted with the key S, the method 40 can further comprise obtaining, from the compartment system 4, the seventh piece of information that is encrypted with the key S, and outputting the seventh piece of information to the second apparatus 2, the partner server 2 in this exemplary embodiment, wherein, after the first apparatus 1, the backend system 1 in this exemplary embodiment, obtains the seventh piece of information, the first apparatus 1 generates an eighth piece of information based at least on the decrypted seventh piece of information and outputs the eighth piece of information to the second apparatus 2. The transmission of the seventh piece of information from the compartment system 4 to the partner server 2 is carried out, for example, by the mobile device 3, preferably via the close-range data communication connection 7 and the remote data communication connection 8.

Accordingly, in exemplary embodiments according to the second aspect of the invention, in which the second piece of information is encrypted with the key S, the method 30 may for this purpose further comprise obtaining from the third apparatus 3, the mobile device 3 in this exemplary embodiment, the seventh piece of information that is encrypted with the key, and outputting the seventh piece of information to the first apparatus 1, the backend system 1 in this exemplary embodiment. The encrypted seventh piece of information is forwarded, for example, by the partner server 2.

For embodiments in which there is a direct data communication connection between the backend system 1 and the compartment system 4, the encrypted seventh piece of information can also be transmitted directly via this data communication connection without forwarding by the mobile device 3 and the partner server 2.

Accordingly, in exemplary embodiments according to the first aspect of the invention, in which the second piece of information is encrypted with the key S, the method 20 may further comprise obtaining the seventh piece of information that is encrypted with the key S, generating an eighth piece of information based at least on the seventh piece of information decrypted with the key (S), and outputting the eighth piece of information to the second apparatus 2, the partner server 2 in this exemplary embodiment. Upon or after obtaining the encrypted seventh piece of information, the backend system 1 decrypts the seventh piece of information and filters out, for example, the pieces of status information relating to the compartment system 4 that are intended for and/or relevant to the partner server 2. The backend system 1 then transmits these pieces of information to the partner server 2 in the eighth piece of information.

Accordingly, in exemplary embodiments according to the second aspect of the invention, in which the second piece of information is encrypted with a key S, the method 30 may further comprise obtaining the eighth piece of information that is based at least on the seventh piece of information decrypted by the first apparatus 1. The eighth piece of information contains, for example, pieces of status information relating to the compartment system 4 that are relevant to the partner server 2 and were filtered from the decrypted seventh piece of information by the backend system 1. Based on the eighth piece of information, the second apparatus 2, the partner server 2 in this exemplary embodiment, can then update a piece of status information concerning an occupancy of one or more compartments 40 of the compartment system 4. For example, the eighth piece of information contains the message that one or more compartments of the compartment system 4 have been opened and/or, for example, that they have been closed again. For example, if the partner server 2 has authorized the opening so that the user 5 can remove one or more shipments or one or more objects from the compartment system 4, the piece of status information relating to the affected compartment or compartments 40 can be changed, for example, from occupied to free. For example, if the opening was authorized due to a shipment or an object being deposited, the piece of status information relating to the affected compartment or compartments 40 can be changed from free to occupied, for example. For example, if the eighth piece of information contains the message that no compartment has been opened, the partner server 2 can transmit an opening request to the backend system 1 again or start an error log.

In some exemplary embodiments according to all aspects of the invention, the key S is generated, for example, by the compartment system 4. The key S is generated by the compartment system 4, for example, at the time or in the event of a close-range data communication connection, for example with optical transmission, Bluetooth, NFC, RFID, WLAN, IrDA or ZigBee, being established between the compartment system 4 and the mobile device 3 of the user 5. For example, the key S is generated as a random value. In some exemplary embodiments, the key S is only temporarily valid. The validity ends, for example, after a predetermined period has elapsed, for example when a maximum period of time without data exchange between the compartment system 4 and the backend system 1 has been exceeded, such as 2 minutes, or after completing the process of opening one or more compartments 40 of the compartment system 4, to name just a few examples. Due to the time-limited validity of the temporary key used for encryption, it is ensured that messages recorded by an attacker and repeatedly sent at a later time expire without effect.

In some exemplary embodiments according to all aspects of the invention, in which the second piece of information is encrypted, the third piece of information contains the key S. The key S is transmitted, for example, by transmitting the third piece of information from the compartment system 4 to the mobile device 3 via a close-range data communication connection 7, from the mobile device 3 to the partner server 2 via a remote data communication connection 8 and then from the partner server 2 to the backend system 1 via a remote data communication connection 9, for example via a cellular mobile radio network. Advantageously, in some exemplary embodiments, the key S is encrypted by the compartment system 4, and so the partner server 2 and the mobile device 3, as well as potential attackers, cannot acquire any knowledge of the key S.

In such embodiments according to the first aspect of the invention, the method 20 may further comprise acquiring the key S by decrypting the encrypted key S. The decryption is carried out, for example, by the backend system 1. The key S is preferably encrypted by means of asymmetric cryptographic encryption such that a so-called public key of the backend system 1 that is known to the compartment system 4 is used to encrypt the key S. The encrypted key S is decryptable with the aid of a so-called private key of the backend system 1.

The term of the public key of the backend system 1, which is known to the compartment system 4, is understood as meaning that this public key is known to at least one of the compartment systems managed by the backend system 1. However, the public key may only be known to the compartment system(s) 4 itself/themselves, since otherwise an attacker with knowledge of this public key may pose as a compartment system 4. The private key of the backend system 1 is stored in an apparatus of the backend system 1 with strict protective measures against unauthorized access. The public key of the backend system 1 is used to encrypt messages that are only decryptable with the private key of the backend system 1. According to the concept of asymmetric encryption, the private key is defined such that it cannot be calculated from the public key at all or only with an extremely large amount of time and calculation effort.

In order to make it more difficult for attackers to access the public key of the backend system 1, the public key of the backend system 1 is not generally known or published, but is, for example, integrated into the firmware of the compartment system 4. For example, for each firmware update, a new asymmetric key pair is generated, with integration of the public key of the backend system 1 into the firmware, forcing a regular replacement of the private key in the backend system 1 and of the public key in all compartment systems managed by the backend system 1, and thus increasing the security against attacks with older, possibly known keys. If an external development service provider is involved in the firmware development, said service provider preferably receives only test version keys that are ineffective in everyday operation of the compartment systems and the backend system 1, i.e. outside a limited test environment. After the created firmware has been passed from the development service provider to the operator of the backend system 1, the operator replaces the test version keys with effective or productive keys. Furthermore, the security can be increased by a challenge-response concept which provides for the backend system 1 to send a challenge message or request message with an integrated, possibly encrypted time stamp to the compartment system 4, and for the compartment system 4 to send the time stamp back to the backend system 1 as a response message or reply message. Key management may also be provided such that each compartment system 4 works with individual asymmetric encryption (which is also changed, for example, with each firmware update), that is to say each compartment system 4 of a plurality of compartment systems managed by the backend system 1 uses a different public key, each of which has its own corresponding private key stored in the backend system 1. For example, the RSA method with an exemplary 2048-bit key value can be used for the asymmetric encryption.

In order to increase the security against attacks, the key S is preferably encrypted by twice asymmetric cryptographic encryption such that a second public key S2 of a fifth apparatus, for example a hardware security module (HSM), is additionally used to encrypt the key S that has already been encrypted by the public key S1 of the backend system 1. For this purpose, in some exemplary embodiments according to the first aspect of the invention, in which the key S is encrypted twice asymmetrically with two public keys S1 and S2 of two asymmetric key pairs S1, S1′ and S2, S2′ by the compartment system 4, wherein the two public keys S1 and S2 are stored in the compartment system 4, wherein the private key S′ of the first key pair, but not the private key S2′ of the second key pair, is known to the first apparatus 1, the method 20 may further comprise: transmitting the twice-encrypted key S to a fifth apparatus that has stored the private key S2′ of the second key pair (but not, for example, the private key S1′ of the first key pair), obtaining, from the fifth apparatus, the once-encrypted key S acquired by the fifth apparatus by decrypting (for example once) the twice-encrypted key S using the private key S2′ of the second key pair, and acquiring the key S by decrypting (for example once) the once-encrypted key S using the private key S1′ of the first key pair.

The key S is thus encrypted, for example, by means of asymmetric cryptographic encryption such that a so-called public key S1 of a first key pair that is known to the compartment system 4 and a second so-called public key S2 of a second key pair that is known to the compartment system 4 are used to encrypt the key S. The corresponding private key S1′ of the first key pair S1, S1′ is stored in the backend system 1 (in particular exclusively there), and the corresponding private key S2′ of the second key pair S2, S2′ is not known to the backend system 1, but is stored in the hardware security module 13 (in particular exclusively there). The encrypted key S is decryptable with the aid of the private key S1′ of the backend system 1 in combination with the private key S2′ of the hardware security module. For this purpose, the backend system 1 transmits, for example, the twice asymmetrically encrypted key S to the hardware security module that provides, for example, “Decryption-as-a-Service”. There, the twice asymmetrically encrypted key S is decrypted once using the private key S2′ of the hardware security module, and the resulting once-encrypted key S is transmitted back to the backend system 1. Subsequently, the backend system 1 can acquire the key S by decrypting the once-encrypted key S obtained with the private key S1′ of the backend system 1. The private key S2′ of the hardware security module is stored, for example, with strict protective measures against unauthorized access and is not exportable, for example. The public key S2 of the hardware security module is used to encrypt messages that are only decryptable with the private key S2′ of the hardware security module. According to the concept of asymmetric encryption, the private key S2′ is defined such that it cannot be calculated from the public key S2 at all or only with an extremely large amount of time and calculation effort. As a result of the double encryption, attackers must infiltrate both the backend system 1 and the hardware security module in order to reach the key S, eliminating a single point of failure. By encrypting the key at least once at all times in the hardware security module, the integrity of the end-to-end encryption between the compartment system 4 and the backend system 1 is maintained.

The above-explained principle of the twice asymmetric encryption of a key, which is generated by a compartment system and is used for symmetric encryption of communication between a first apparatus and the compartment system, with two public keys which are stored in the compartment system and the corresponding private keys of which are stored in the first apparatus and in a fifth apparatus, wherein only one of the two private keys is known to the first apparatus and the other of the two private keys is known to the fifth apparatus (and the first and the fifth apparatus do not reciprocally have access to the private key respectively stored in the other apparatus), is also intended to be understood as disclosed independently and separately from the other features of the above-described aspects of the invention, but one or more of the features of these aspects are also intended to be understood as disclosed in a manner belonging to this principle by way of example.

In some exemplary embodiments according to all aspects of the invention, in which the fourth piece of information is transmitted to the first apparatus 1, the backend system 1 in this exemplary embodiment, the compartment system 4 is further configured to generate a new key, wherein the new key S_neu and a piece of information that is based at least on the fourth piece of information are output, in particular together, from the second apparatus 2, the partner server 2 in this exemplary embodiment, to the first apparatus 1, wherein the first apparatus 1 replaces the key S with the new key S_neu based on this piece of information. A new key is generated, for example, after an interruption of the close-range data communication connection 7 between the compartment system 4 and the mobile device 3 or due to a time-out at the compartment system 4. The new key S_neu is transmitted from the compartment system 4 to the partner server 2 via the mobile device 3. For example, the partner server 2 transmits the new key S_neu along with the session ID to the backend system 1. The backend system 1 identifies the associated session by the session ID and can determine, for example by the presence of the previously used key S, that the authentication process of the partner server 2 with respect to the backend system 1 has already been completed. The backend system 1 replaces the key S corresponding to the session with the new key S_neu. Thus, there is no need to re-transmit the pieces of authentication information (FIG. 2, step 21 and FIG. 3, step 33) and check the authentication of the partner server 2 (FIG. 2, step 22).

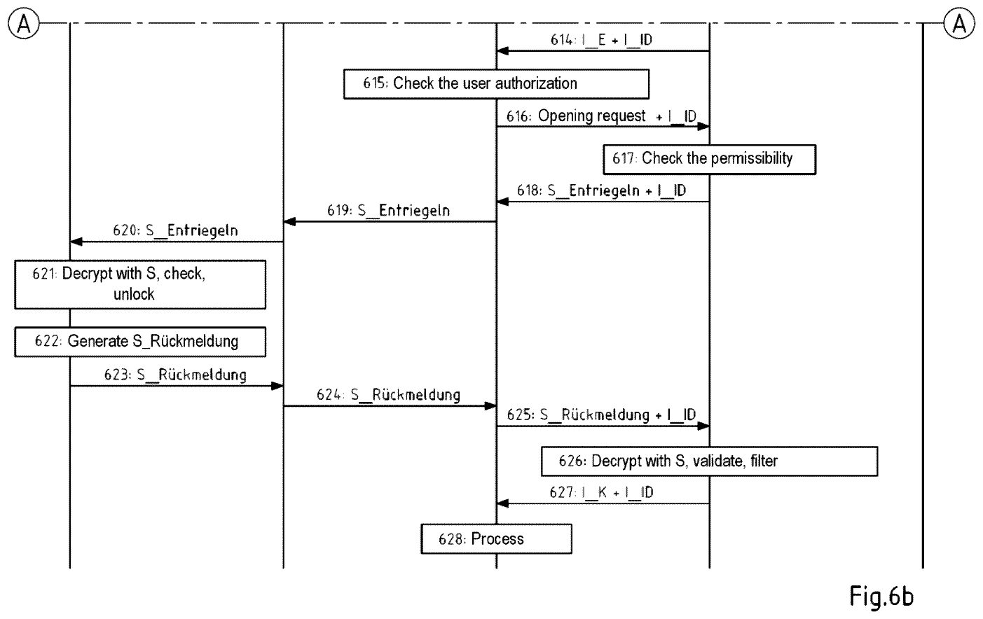

FIG. 6 (divided into FIG. 6a and FIG. 6b) is a flow diagram of an exemplary embodiment of a method according to the present invention with a detailed illustration of individual steps and of the respectively associated data exchange between the backend system 1, the partner server 2, the mobile device 3, the compartment system 4 and a hardware security module (HSM) 13.

In step 601, the user 5 operates the app executed on the mobile device 3 in order to gain access to one or more compartments 40 of the compartment system 4. Specifically, in step 601, the mobile device 3 addresses a request to the compartment system 4 to establish a close-range data communication connection, such as optical transmission, Bluetooth, ZigBee, NFC, RFID or WLAN, as illustrated in FIG. 1 with the connecting line provided with reference sign 7.

If the close-range data communication connection between the mobile device 3 and the compartment system 4 is successfully established or realized, the compartment system 4 generates a random temporary key S in step 602. In step 603, the temporary key S is then subjected by the compartment system 4 to twice asymmetric encryption, for example using RSA with two 2048-bit keys S1 and S2. The two required public keys of two asymmetric key pairs have been stored in the compartment system 4 for this purpose, for example during its manufacture or start-up, or when the firmware is installed or during the last firmware update. The corresponding private key S1′ of the first key pair S1, S1′ is stored in the backend system 1, and the corresponding private key S2′ of the second key pair S2, S2′ is not known to the backend system 1, but is stored in the hardware security module 13. In step 604, the twice-encrypted key V(V(S)) is transmitted from the compartment system 4 as a third piece of information to the mobile device 3 via the established close-range data communication connection.

In step 605, the mobile device 3 transmits the encrypted key V(V(S)) to the partner server 2 via a remote data communication connection that has already been established or is now to be established. In steps 606 and 607, the partner server 2 generates a session ID I_ID and its piece of authentication information I_A, for example a signature. Steps 606, 607 and 608 can easily be performed in a different order. The partner server then transmits the encrypted key V(V(S)) as well as its piece of authentication information I_A as the first piece of information and the session ID I_ID as the fourth piece of information to the backend system 1 in step 608. The backend system 1 then performs the process of authenticating the partner server 2. For this purpose, it is checked in step 609 whether the piece of authentication information I_A transmitted by the partner server 2 matches, can be mapped to or corresponds to the pieces of authentication information stored in the backend system 1 for the partner 6.

If the backend system 1 determines, when performing the process of authenticating the partner 6 in step 609, that the transmitted piece of authentication information I_A matches or corresponds to the stored pieces of authentication information, then the backend system 1 authenticates the partner 6. To establish secure data exchange, with symmetric end-to-end encryption with the key S (for example by means of AES with a 256-bit key), between the backend system 1 and the compartment system 4 during the current session or the current authentication, the backend system 1 transmits the twice asymmetrically encrypted key V(V(S)) received from the partner server 2 to the hardware security module 13 in step 610. This hardware security module first decrypts the twice asymmetrically encrypted key V(V(S)) in step 611 with the aid of the private key S2′ of the hardware security module 13 and then transmits the once-encrypted key V(S) obtained to the backend system 1 in step 612. Then, in step 613, the backend system 1 first decrypts the asymmetrically encrypted key V(S) received from the hardware security module 13 with the aid of the private key S1′ of the backend system 1 in order to obtain the key S. Then, in step 614, the backend system 1 transmits a piece of information about successful session creation I_E together with the session ID I_ID to the partner server 2 to assign the piece of information I_E. For this purpose, the piece of information is transmitted from the backend system 1 to the partner server 2 via the remote data communication connection 9.

In an internal process in step 615, the partner server 2 checks, for example, whether the user 5 is authorized to access one or more compartments 40 of the compartment system 4 that are managed by the partner server. The check can also be carried out, for example, with the aid of the piece of information I_E received from the backend system 1, by the partner 6 being able to ensure, for example in the case of successful session creation, that the mobile device 3 is in the vicinity of the compartment system 4, since only then does the compartment system 4 generate and output the session key S, as explained in step 602. If the result of a check by the partner is that the compartment or multiple compartments 40 of the compartment system 4 is/are intended to be opened for the user 5, an opening request is transmitted by the partner server 2 together with the session ID I_ID to the backend system 1 in step 616. The backend system 1 then checks whether the opening request from the partner 6 is permissible, for example whether the partner 6 manages the compartment or multiple compartments 40 of the compartment system 4.

If the check reveals that the opening request from the partner 6 is authorized, the backend system 1 transmits a command S_Entriegeln encrypted with the key S and/or signed with this key to the compartment system 4 in steps 618 to 620 for unlocking a compartment or multiple compartments 40. The encrypted or signed command S_Entriegeln is first transmitted in step 618 together with the session ID I_ID from the backend system 1 to the partner server 2 via the remote data communication connection 9. In step 619, the partner server 2 transmits the encrypted or signed command S_Entriegeln to the mobile device 3 via the remote data communication connection 8, and the mobile device 3 then transmits the encrypted or signed command S_Entriegeln to the compartment system 4 via the close-range data communication connection 7 in step 620. For embodiments in which there is a direct data communication connection between the backend system 1 and the compartment system 4, the encrypted or signed command S_Entriegeln can also be transmitted directly via this data communication connection without forwarding by the partner server 2 and the mobile device 3. After the compartment system 4 has received the encrypted or signed command S_Entriegeln, the compartment system 4 decrypts it in step 621 with the key S and/or checks the authenticity/integrity of the command S_Entriegeln on the basis of its signature with the key S and unlocks (for example only in the case of successful decryption of the command S_Entriegeln and/or a check of the authenticity/integrity of the command S_Entriegeln with a positive result) the specified compartment(s), so that the user 5 gains access to the compartment or compartments 40.

In step 622, the compartment system 4 then generates feedback for the backend system 1, encrypts and/or signs this feedback with the key S to form S_Rückmeldung and transmits the encrypted or signed feedback in steps 623 to 625 from the compartment system 4 to the backend system 1 via the mobile device 3 and the partner server 2. In step 625, the partner server 2 transmits the session ID I_ID in parallel with the message S_Rückmeldung so that the received piece of information can be assigned to the session by the backend system 1. For embodiments in which there is a direct data communication connection between the backend system 1 and the compartment system 4, the encrypted or signed message S_Rückmeldung can also be transmitted directly via this data communication connection without forwarding by the mobile device 3 and the partner server 2. In step 626, the backend system 1 receives the message S_Rückmeldung, decrypts it with the key S and/or checks the authenticity/integrity of the command S_Rückmeldung using the signature with the key S, and generates a corresponding plain text message I_K based on the pieces of information contained in S_Rückmeldung. In step 627, the plain text message is then transmitted to the partner server 2 together with the session ID I_ID. In step 628, the plain text message I_K can be used there, for example, to update the stored current occupancy of the compartments 40 of the compartment system 4 with the user-compartment assignment, taking into account the current change in the compartment occupancy.

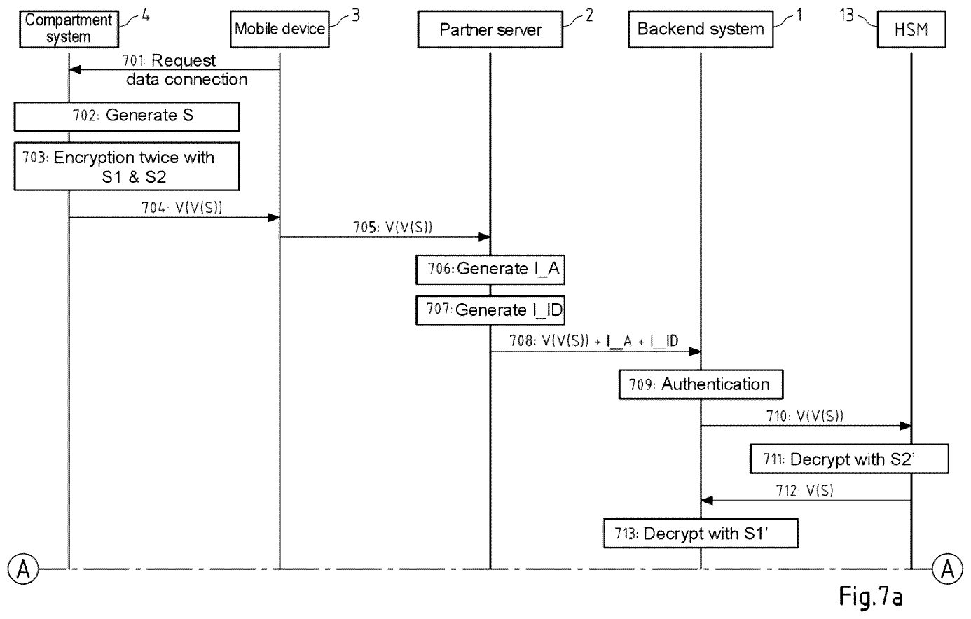

FIG. 7 (divided into FIG. 7a and FIG. 7b) is a flow diagram of an exemplary embodiment of a method according to the present invention with a detailed illustration of individual steps, wherein steps 701 to 713 correspond to steps 601 to 613 illustrated in FIG. 6, wherein with the transition from FIG. 6 to FIG. 7 the leading digit of the step numbering was changed from 6 to 7 for identical or corresponding steps. In the following, the exemplary embodiment of the method illustrated in FIG. 7 will be explained mainly by reference to the differences to the embodiment illustrated by way of example in FIG. 6.

After the initialization of the session in steps 701 to 713 has been successfully completed, it may be the case at any point in the method explained in FIG. 6 (steps 614-627) that the compartment system 4 generates a new key (S_neu) in step 730, encrypts it twice asymmetrically in step 731 and accordingly transmits the new twice asymmetrically encrypted key V(V(S_neu)) to the mobile device 3 in step 732. A new key (S_neu) is generated, for example, after an interruption of the close-range data communication connection 7 between the compartment system 4 and the mobile device 3 or after rejecting the only temporarily valid key (S) due to a time-out at the compartment system 4. In step 733, the mobile device 3 then transmits V(V(S_neu)) to the partner server 2 which transmits it to the backend system 1 in step 734 together with the session ID I_ID. The session ID I_ID allows the backend system 1 to assign the key to a current session in step 735 and to determine that the initialization of the session has already been completed and an old key (S) is present. According to steps 710 to 713, the backend system 1 acquires the new key (S_neu) in steps 736 to 739 and in step 740 replaces the previously used old key (S) with the new key (S_neu) which is then used for the end-to-end encryption of the data communication between the backend system 1 and the compartment system 4. Subsequently, the method can be continued without modification, as explained in FIG. 6, for example by transmitting the opening request in step 616.

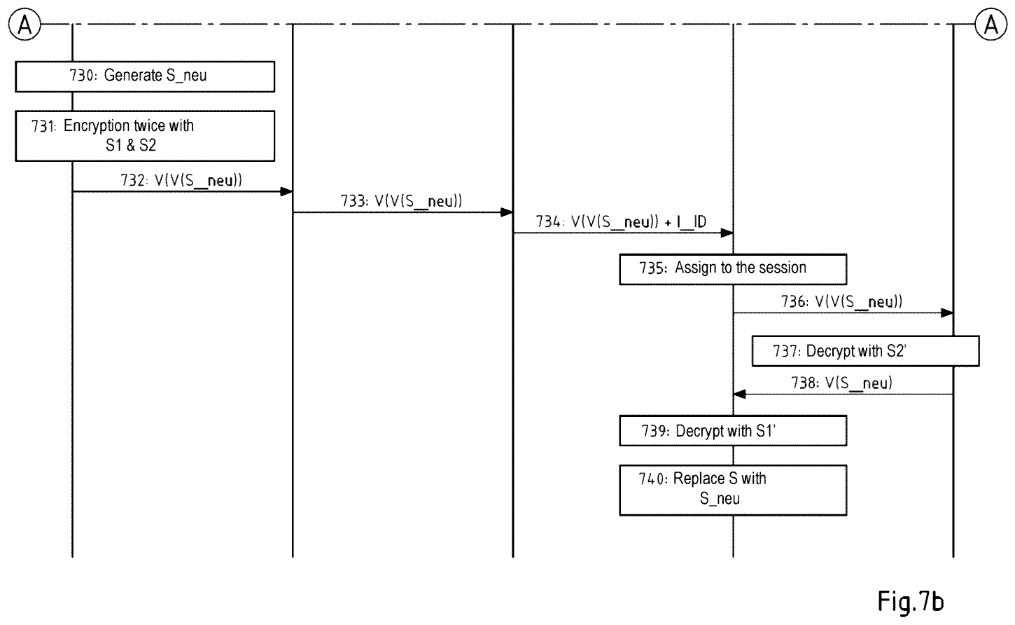

FIG. 8 shows a schematic representation of an exemplary embodiment of an apparatus according to the first or second aspect of the invention, for example a backend system 1 or a partner server 2.

The apparatus 80 comprises a processor 81, a program memory 82, a main memory 83, an optional useful data memory 84 and one or more communication interface(s) 85. The processor executes, for example, a program according to the first or second aspect of the invention, which is stored in the program memory 82, for example as firmware. The main memory 83 is used in particular to store temporary data during the execution of the program.

The useful data memory 84 is used to store data that are required during execution of the program. In the present case, said data may be, for example, a first and/or second piece of information and/or a third piece of information.

In an exemplary embodiment in which the apparatus 80 is an apparatus which performs the method according to the first aspect of the invention, the apparatus 80 stores one or more pieces of authentication information in the useful data memory 84. In addition, further pieces of information can be stored in the useful data memory 84. For example, the apparatus 80 stores data for managing compartments 40 of one or more compartment systems 4 and/or relating to partners 6. The useful data memory 84 also contains, for example, pieces of information about a plurality of compartment systems 4 and, for example, pieces of information about when and/or how the apparatus 80 can communicate with the compartment systems 4. This applies, for example, to the output of the second piece of information.

In particular, in the exemplary embodiment described herein, the communication interface(s) 85 may comprise at least one interface for communication with other units of the system, in particular with the partner server 2 or the compartment system 4. This communication can be based, for example, on the Internet Protocol (IP). For example, at least one of the communication interface(s) 85 is configured as a Local Area Network (LAN) interface. However, the communication connection can also be completely or partially radio-based.

In an exemplary embodiment in which the apparatus 80 is an apparatus which performs the method according to the second aspect of the invention, the apparatus 80 stores, for example, the first piece of information in the useful data memory 84. The useful data memory 84 also contains, for example, pieces of information about a plurality of compartment systems 4, their respective contents, users 5 such as depositors and collectors, and/or communication with the users 5.

In this exemplary embodiment, the communication interface(s) 85 may also comprise at least one interface for communication with other units of the system, in particular with the backend server 1 and the mobile device 3. This communication can be based, for example, on the Internet Protocol (IP). For example, at least one of the communication interface(s) 85 is configured as a Local Area Network (LAN) interface. However, the communication connection may also be completely or partially radio-based in this exemplary embodiment.

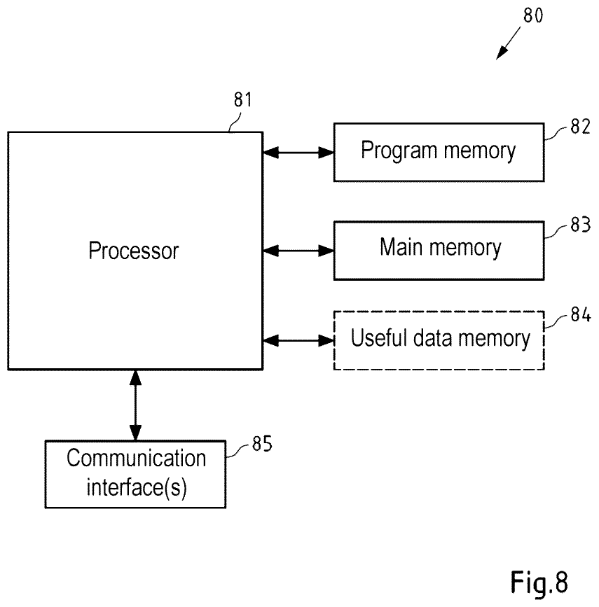

FIG. 9 shows a schematic representation of an exemplary embodiment of an apparatus according to the fourth aspect of the invention, for example a compartment system 4 or its control unit.

The apparatus 90 comprises a processor 91, a program memory 92, a main memory 93, a useful data memory 94, one or more communication interface(s) 95, an actuation unit 96 for the locks or lock control units of the compartments 40 of the compartment system 4, one or more optional sensors 97, an optional capture unit 98 and an optional input unit/user interface 99. The processor 91 executes, for example, a program according to the fourth aspect of the invention, which is stored in the program memory 92, for example as firmware. The main memory 93 is used in particular to store temporary data during execution of this program.

The useful data memory 94 is used to store data that are required during execution of the program. In the present case, said data may be, for example, the obtained second piece of information, the public keys used to encrypt the session key S and/or the session key S.

The communication interface(s) 95 comprise(s), for example, an interface for wireless communication with the apparatus 3, for example by means of optical transmission and/or by means of communication based on electrical, magnetic or electromagnetic signals or fields, in particular Bluetooth, NFC and/or RFID (Radio Frequency Identification). In some embodiments, the apparatus 90 is further configured, for example, for direct communication with the apparatus 1, that is to say has, for example, a communication interface that allows access to the Internet or to another network to which the apparatus 1 is connected.

The actuation unit 96 allows a single compartment 40 of the compartment system 4 to be opened or unlocked specifically in order to allow opening, in particular by actuating the lock of the compartment 40 or a lock control unit of the compartment 40. Additionally or alternatively, it is possible to cause the locking of a compartment 40 (for example if the compartment 40 is not automatically/mechanically locked again when the door of the compartment 40 is closed). The actuation unit 96 is connected, for example, via respective wiring to all locks or lock control units of the compartment system 4 or is connected to a bus to which all locks or lock control units of the compartment system 4 are also connected.

The sensors 97 are optional and are compartment-specific, for example. A sensor makes it possible to detect, for example, whether a respective shipment or a respective object is located in a respective compartment 40, whether a shipment or an object is/has been deposited (such as placed) in the compartment 40 and/or is/has been removed from the compartment 40, and/or whether the door of the compartment 40 is open or closed.

The capture unit 98 is optional and, in one exemplary embodiment, is a scanner which can optically capture pieces of information, e.g. a barcode or QR code, e.g. from a screen of a mobile apparatus 3. The capture unit 98 can be additionally or alternatively able to capture and process acoustic signals, e.g. by means of voice recognition.

The input unit/user interface 99 is optional and is configured to communicate with a user 5. The device may comprise, for example, an output unit for displaying (e.g. via a screen or via compartment-specific illuminated displays (e.g. for representing a respective occupied/unoccupied state)) or acoustically outputting pieces of information and/or a unit for obtaining pieces of information and/or data (e.g. a keyboard or a touch-sensitive screen with a screen keyboard or a voice recognition module) from the people. Preferably, however, no input unit/user interface 99 is provided and the user 5 communicates with the compartment system 4 only via the mobile device 3, for example in order to reduce the related maintenance and/or repair effort (e.g. due to vandalism) and/or the manufacturing costs.

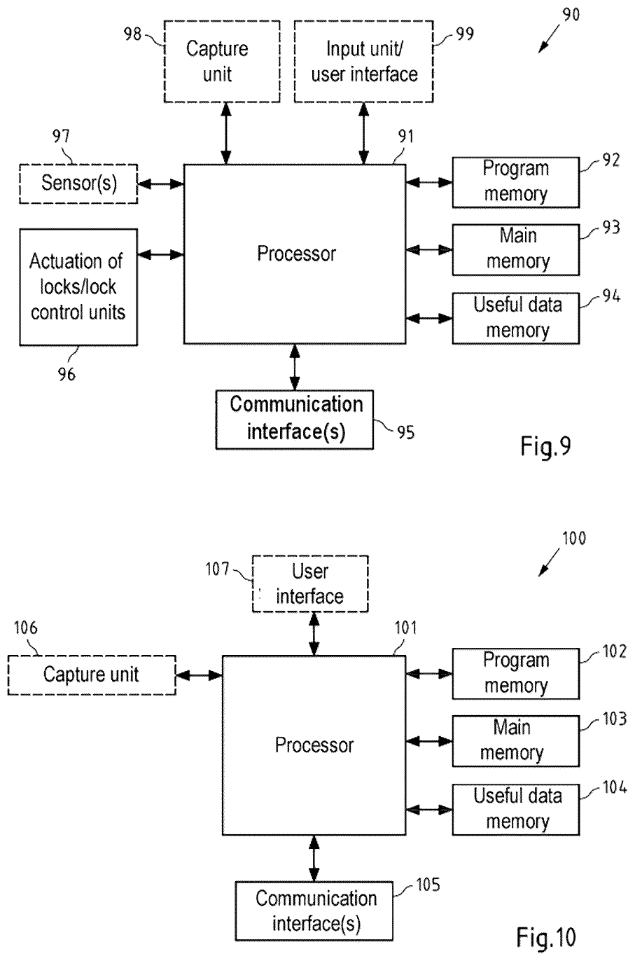

FIG. 10 shows a schematic representation of an exemplary embodiment of an apparatus according to the third aspect of the invention, for example a mobile apparatus 3. The apparatus 100 may represent, for example, a mobile telephone or a portable scanning device of a delivery agent/supplier (a so-called handheld scanner), that is to say a device which is configured to optically capture shipment or delivery data, in particular in the form of 2D or 3D barcodes, from the shipment or delivery. If the apparatus 100 represents the device of the user 5, it may be in particular a mobile device 3, that is to say in particular a mobile telephone with the ability to execute even more complex programs, so-called apps, independently.

The apparatus 100 comprises a processor 101, a program memory 102, a main memory 103, a useful data memory 104, one or more communication interface(s) 105, an optional capture unit 106 for capturing pieces of information and an optional user interface 107.

The processor 101 executes, for example, a program according to the third aspect of the invention, which is stored in the program memory 102, for example as an app or as firmware. The main memory 103 is used in particular to store temporary data during execution of the program.

The useful data memory 104 is used to store data that are required during execution of the program, for example one or more third pieces of information.

The communication interface(s) 105 comprise(s) one or more interfaces for communication between the apparatus 100 and the apparatus 2. The interface may be based, for example, on IP, but, due to the portability of the apparatus 100, may use a wireless transmission technology as the physical layer, which is based, for example, on cellular mobile radio (e.g. GSM, E-GSM, UMTS, LTE, 5G) or WLAN. The communication interface(s) 105 further optionally comprise(s) an interface for communicating with the compartment system 4, for example based on optical transmission, Bluetooth, ZigBee, NFC, RFID, WLAN or IrDA. In this case, a transmission technology with a relatively short range, for example less than 100 m or 10 m or 5 m, may be sufficient and possibly even desirable in order to make it more difficult for third parties to listen to the transmission.

The user interface 107 can be configured as a screen and keyboard or as a touch-sensitive display (touchscreen), possibly with additional acoustic and/or haptic signaling units. The display of a second piece of information via the user interface 107 can make a separate interface 107 for communicating with the compartment system 4 unnecessary, if the second piece of information can be input to a user interface of the compartment system 4 (see user interface 99 in FIG. 9). The capture unit 106 for capturing a first piece of information and/or a hash value (for example in the form of an optical scanning unit) is only optionally present, for example.

The exemplary embodiments of the present invention that are described in this specification are also intended to be understood as disclosed in all combinations with each other. In particular, the description of a feature covered by an embodiment—unless explicitly stated to the contrary—is also not intended to be understood in the present case as meaning that the feature is imperative or essential for the function of the exemplary embodiment. The sequence of the method steps described in this specification in the individual flowcharts is not mandatory; alternative sequences of the method steps are conceivable. The method steps can be implemented in different ways; an implementation in software (through program instructions), hardware or a combination of both for implementing the method steps is thus conceivable. Terms used in the patent claims, such as “comprise”, “have”, “include”, “contain” and the like, do not exclude other elements or steps. The wording “at least partially” includes both the “partially” case and the “completely” case. The wording “and/or” is intended to be understood as meaning that both the alternative and the combination are intended to be disclosed, i.e. “A and/or B” means “(A) or (B) or (A and B)”. A plurality of units, persons or the like means multiple units, persons or the like in the context of this specification. The use of the indefinite article does not exclude a plurality. A single device can perform the functions of multiple units or devices mentioned in the patent claims. Reference signs specified in the patent claims are not intended to be regarded as limitations for the means and steps employed.

Additionally, the following numbered embodiments are disclosed:

Method, for example performed on a first apparatus (1), the method comprising:
obtaining (21) a first piece of information from a second apparatus (2), wherein the first piece of information is associated with the second apparatus (2);
authenticating (22) the second apparatus (2) based on at least the first piece of information;
generating (23) a second piece of information, wherein a third apparatus (3) different from the second apparatus (2) or a user (5) of the third apparatus (3) can gain access to one or more compartments (40) of a compartment system (4) using the second piece of information; and outputting (24) the second piece of information, wherein a positive result of the authentication (22) of the second apparatus (2) is a necessary condition for outputting (24) the second piece of information.

Method according to Embodiment 1, wherein the second piece of information is output to the second apparatus (2).

Method according to one of the preceding Embodiments, further comprising: obtaining a third piece of information from the second apparatus (2), wherein the third piece of information is associated with the compartment system (4).

Method according to one of the preceding Embodiments, further comprising: obtaining a fourth piece of information from the second apparatus (2), wherein the fourth piece of information is associated with the third apparatus (3), and wherein, after obtaining the fourth piece of information, at least a piece of information that is transmitted between the first apparatus (1) and the second apparatus (2) is based at least on the fourth piece of information.

Method according to one of the preceding Embodiments, further comprising: obtaining a fifth piece of information from the second apparatus (2), wherein obtaining the fifth piece of information is a further necessary condition for outputting (24) the second piece of information.

Method according to one of the preceding Embodiments, further comprising:
generating a sixth piece of information, wherein the sixth piece of information is based on a result of the authentication (22) of the second apparatus (2); and
outputting the sixth piece of information to the second apparatus (2).

Method, for example performed on a second apparatus (2), comprising: obtaining (31) a third piece of information from a third apparatus (3);
generating (32) a first piece of information, wherein the first piece of information is associated with the second apparatus (2); and
outputting (33) the first piece of information to a first apparatus (1) in order to allow the first apparatus (1) to authenticate (22) the second apparatus (2) based on at least the first piece of information, wherein a positive result of the authentication is a necessary condition for outputting (24) a second piece of information from the first apparatus (1), wherein a third apparatus (3) or a user (5) of the third apparatus (3) can gain access to one or more compartments (40) of a compartment system (4) using the second piece of information, and wherein obtaining (31) the third piece of information is a necessary condition for outputting (33) the first piece of information.

Method according to Embodiment 7, further comprising:
obtaining the second piece of information from the first apparatus (1); and
outputting the second piece of information to the third apparatus (3).

Method according to either of Embodiments 7 and 8, further comprising:
outputting the third piece of information to the first apparatus (1), wherein the third piece of information is associated with the compartment system (4).

Method according to one of Embodiments 7 to 9, further comprising: generating a fourth piece of information, wherein the fourth piece of information is associated with the third apparatus (3), and wherein, after obtaining the fourth piece of information by the first apparatus (1), at least a piece of information that is transmitted between the first apparatus (1) and the second apparatus (2) is based at least on the fourth piece of information; and
outputting the fourth piece of information to the first apparatus (1).

Method according to one of Embodiments 7 to 10, further comprising: generating a fifth piece of information; and
outputting the fifth piece of information to the first apparatus (1), wherein obtaining the fifth piece of information by the first apparatus (1) is a further necessary condition for outputting (24) the second piece of information by the first apparatus (1).

Method according to Embodiment 11, further comprising:
obtaining a sixth piece of information from the first apparatus (1), wherein the sixth piece of information is based on the result of the authentication (22) of the second apparatus (2), and wherein a positive result of the authentication (22) is a necessary condition for outputting the fifth piece of information.

Method, for example performed on a third apparatus (3), comprising:
obtaining (41) a third piece of information from a compartment system (4) or generating (41) a third piece of information; and
outputting (42) the third piece of information to a second apparatus (2), wherein obtaining (31) the third piece of information by the second apparatus (2) is a necessary condition for outputting (33) a first piece of information to a first apparatus (1) by the second apparatus (2), wherein a positive result of the authentication (22) of the second apparatus (2) by the first apparatus (1) based at least on the first piece of information is a necessary condition for outputting (24) a second piece of information by the first apparatus (1), wherein the third apparatus (3) or a user (5) of the third apparatus can gain access to one or more compartments (40) of a compartment system (4) using the second piece of information.

Method according to Embodiment 13, further comprising:
obtaining the second piece of information from the second apparatus (2); and
outputting the second piece of information to the compartment system (4).

Method, performed on a compartment system (4) in a system having the first apparatus (1) according to Embodiment 1, the second apparatus (2) according to Embodiment 7 and the third apparatus (3) according to Embodiment 13, the method comprising: obtaining (51) the second piece of information; and
determining (52) whether access to one or more compartments (40) of the compartment system (4) can be granted based on the second piece of information.

Method according to Embodiment 15, wherein the second piece of information is obtained from the third apparatus (3).

Method according to either of Embodiments 15 and 16, further comprising: generating the third piece of information; and
outputting the third piece of information to the third apparatus (3).

Method according to one of the preceding Embodiments, wherein the second piece of information is encrypted with a key (S), wherein the key (S) is stored in the compartment system (4), wherein the key (S) is not known to the second (2) and to the third apparatus (3).

Method according to Embodiment 18, insofar as indirectly or directly referring back to Embodiment 1, further comprising:
obtaining the key (S) for encrypted communication with the compartment system (4).

Method according to Embodiment 19, further comprising: obtaining a seventh piece of information that is encrypted with the key (S);
generating an eighth piece of information based at least on the seventh piece of information decrypted with the key (S); and
outputting the eighth piece of information to the second apparatus (2).

Method according to Embodiment 20, wherein the seventh piece of information is obtained from the second apparatus (2).

Method according to Embodiment 18, insofar as indirectly or directly referring back to Embodiment 7, further comprising:
obtaining, from the third apparatus (3), a seventh piece of information that is encrypted with the key (S);
outputting the seventh piece of information to the first apparatus (1);
obtaining an eighth piece of information that is based at least on the seventh piece of information decrypted by the first apparatus (1).

Method according to Embodiment 22, wherein a piece of status information concerning an occupancy of one or more compartments (40) of the compartment system (4) is updated based on the eighth piece of information in the second apparatus (2).

Method according to Embodiment 18, insofar as indirectly or directly referring back to Embodiment 13, further comprising:
obtaining, from the compartment system (4), a seventh piece of information that is generated by the compartment system (4) and is encrypted with the key (S), wherein, after the first apparatus (1) obtains the seventh piece of information, the first apparatus (1) generates an eighth piece of information based at least on the decrypted seventh piece of information and outputs the eighth piece of information to the second apparatus (2); and
outputting the seventh piece of information to the second apparatus (2).

Method according to Embodiment 18, insofar as indirectly or directly referring back to Embodiment 15, further comprising:
generating a seventh piece of information that is encrypted with the key (S), wherein, after the first apparatus (1) obtains the seventh piece of information, the first apparatus (1) generates an eighth piece of information based on the decrypted seventh piece of information and outputs the eighth piece of information to the second apparatus (2); and
outputting the seventh piece of information.

Method according to one of Embodiments 18 to 25, wherein the key (S) is generated by the compartment system (4).

Method according to one of Embodiments 18 to 26, insofar as indirectly or directly referring back to one of Embodiments 3, 9, 13 or 17, wherein the third piece of information contains at least the key (S).

Method according to one of Embodiments 18 to 27, wherein the key (S) is only temporarily valid.

Method according to either of Embodiments 27 and 28, insofar as indirectly or directly referring back to Embodiment 1, wherein the key (S) is encrypted by the compartment system (4), further comprising:
acquiring the key (S) by decrypting the encrypted key (S).

Method according to Embodiment 29, wherein the key (S) is encrypted twice asymmetrically with two public keys (S1; S2) of two asymmetric key pairs (S1, S1′; S2, S2′), wherein the two public keys (S1; S2) are stored in the compartment system (4), wherein the corresponding private key (S1′) of the first key pair, but not the private key (S2′) of the second key pair, is known to the first apparatus (1), further comprising:
transmitting the twice-encrypted key (S) to a fifth apparatus that has stored the private key (S2′) of the second key pair;
obtaining, from the fifth apparatus, the once-encrypted key (S) acquired by the fifth apparatus by decrypting the twice-encrypted key (S) using the private key (S2′) of the second key pair;
and acquiring the key (S) by decrypting the once-encrypted key (S) using the private key (S1′) of the first key pair.

Method according to one of the preceding Embodiments, insofar as indirectly or directly referring back to one of Embodiments 3, 9, 13 or 17, wherein the authentication (22) of the second apparatus (2) by the first apparatus (1) is further based on the third piece of information.

Method according to one of Embodiments 25 to 31, insofar as indirectly or directly referring back to Embodiment 4 or Embodiment 10, wherein the compartment system (4) is configured to generate a new key, wherein the new key (S_neu) and a piece of information that is based at least on the fourth piece of information are output, in particular together, from the second apparatus (2) to the first apparatus (1), wherein the first apparatus (1) replaces the key (S) with the new key (S_neu) based on this piece of information.

Apparatus or system comprising at least more than one apparatus, configured to perform and/or control the method according to one of the preceding Embodiments or comprising respective means for performing and/or controlling the steps of the method according to one of the preceding Embodiments.

Computer program comprising program instructions which cause a processor to perform and/or control the method according to one of Embodiments 1-32 when the computer program is running on the processor.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A first apparatus comprising at least one processor and at least one memory comprising program code, wherein the memory and the program code are configured to cause the first apparatus having the at least one processor to perform and/or control:
obtaining a first piece of information from a second apparatus, wherein the first piece of information is associated with the second apparatus;
authenticating the second apparatus based on at least the first piece of information;
generating a second piece of information, wherein a third apparatus different from the second apparatus or a user of the third apparatus can gain access to one or more compartments of a compartment system using the second piece of information; and
outputting the second piece of information, wherein a positive result of the authentication of the second apparatus is a necessary condition for outputting the second piece of information.

2. The first apparatus according to claim 1, wherein the second piece of information is output to the second apparatus.

3. The first apparatus according to claim 1, wherein the memory and the program code are configured to cause the first apparatus to perform and/or control at least one of the following:
obtaining a third piece of information from the second apparatus, wherein the third piece of information is associated with the compartment system, and wherein for example the authentication of the second apparatus by the first apparatus is further based on the third piece of information; or
obtaining a fourth piece of information from the second apparatus, wherein the fourth piece of information is associated with the third apparatus, and wherein, after obtaining the fourth piece of information, at least a piece of information that is transmitted between the first apparatus and the second apparatus is based at least on the fourth piece of information; or
obtaining a fifth piece of information from the second apparatus, wherein obtaining the fifth piece of information is a further necessary condition for outputting the second piece of information; or
generating a sixth piece of information, wherein the sixth piece of information is based on a result of the authentication of the second apparatus, and outputting the sixth piece of information to the second apparatus.

4. The first apparatus according to claim 1, wherein the second piece of information is encrypted with a key, wherein the key is stored in the compartment system, wherein the key is not known to the second and to the third apparatus.

5. The first apparatus according to claim 4, wherein the memory and the program code are configured to cause the first apparatus to perform and/or control:
obtaining the key for encrypted communication with the compartment system.

6. The first apparatus according to claim 4, wherein the memory and the program code are configured to cause the first apparatus to perform and/or control:
obtaining, for example from the second apparatus, a seventh piece of information that is encrypted with the key;
generating an eighth piece of information based at least on the seventh piece of information decrypted with the key; and
outputting the eighth piece of information to the second apparatus.

7. The first apparatus according to claim 4, wherein the memory and the program code are configured to cause the first apparatus to perform and/or control:
obtaining a third piece of information from the second apparatus, wherein the third piece of information is associated with the compartment system, wherein the third piece of information contains at least the key.

8. The first apparatus according to claim 4, wherein the key is generated by the compartment system and/or wherein the key is only temporarily valid.

9. The first apparatus according to claim 8, wherein the key is encrypted by the compartment system, wherein the memory and the program code are configured to cause the first apparatus to perform and/or control:
acquiring the key by decrypting the encrypted key.

10. The first apparatus according to claim 9, wherein the key is encrypted twice asymmetrically with two public keys of two asymmetric key pairs, wherein the two public keys are stored in the compartment system, wherein the corresponding private key of the first key pair, but not the private key of the second key pair, is known to the first apparatus,
wherein the memory and the program code are configured to cause the first apparatus to perform and/or control:
transmitting the twice-encrypted key to a fifth apparatus that has stored the private key of the second key pair;
obtaining, from the fifth apparatus, the once-encrypted key acquired by the fifth apparatus by decrypting the twice-encrypted key using the private key of the second key pair; and
acquiring the key by decrypting the once-encrypted key using the private key of the first key pair.

11. The first apparatus according to claim 4, wherein the memory and the program code are configured to cause the first apparatus to perform and/or control:
obtaining a fourth piece of information from the second apparatus, wherein the fourth piece of information is associated with the third apparatus, and wherein, after obtaining the fourth piece of information, at least a piece of information that is transmitted between the first apparatus and the second apparatus is based at least on the fourth piece of information.

12. The first apparatus according to claim 11, wherein the compartment system is configured to generate a new key, wherein the new key and the piece of information that is based at least on the fourth piece of information are output, in particular together, from the second apparatus to the first apparatus, wherein the first apparatus replaces the key with the new key based on this piece of information.

13. A second apparatus comprising at least one processor and at least one memory comprising program code, wherein the memory and the program code are configured to cause the second apparatus having the at least one processor to perform and/or control:
obtaining a third piece of information from a third apparatus;
generating a first piece of information, wherein the first piece of information is associated with the second apparatus; and
outputting the first piece of information to a first apparatus in order to allow the first apparatus to authenticate the second apparatus based on at least the first piece of information, wherein a positive result of the authentication is a necessary condition for outputting a second piece of information from the first apparatus, wherein a third apparatus or a user of the third apparatus can gain access to one or more compartments of a compartment system using the second piece of information, and wherein obtaining the third piece of information is a necessary condition for outputting the first piece of information.

14. The second apparatus according to claim 13, wherein the memory and the program code are configured to cause the second apparatus to perform and/or control:
obtaining the second piece of information from the first apparatus; and
outputting the second piece of information to the third apparatus.

15. The second apparatus according to claim 13, wherein the second piece of information is encrypted with a key, wherein the key is stored in the compartment system, wherein the key is not known to the second and to the third apparatus.

16. The second apparatus according to claim 15, wherein the memory and the program code are configured to cause the second apparatus to perform and/or control:
obtaining, from the third apparatus, a seventh piece of information that is encrypted with the key;
outputting the seventh piece of information to the first apparatus;
obtaining an eighth piece of information that is based at least on the seventh piece of information decrypted by the first apparatus, wherein for example a piece of status information concerning an occupancy of one or more compartments of the compartment system is updated based on the eighth piece of information in the second apparatus.

17. The second apparatus according to claim 15, wherein the key is generated by the compartment system and/or wherein the key is only temporarily valid.

18. The second apparatus according to claim 15, wherein the third piece of information contains at least the key and/or wherein the authentication of the second apparatus by the first apparatus is further based on the third piece of information.

19. The second apparatus according to claim 15, wherein the memory and the program code are configured to cause the second apparatus to perform and/or control:
generating a fourth piece of information, wherein the fourth piece of information is associated with the third apparatus, and wherein, after obtaining the fourth piece of information by the first apparatus, at least a piece of information that is transmitted between the first apparatus and the second apparatus is based at least on the fourth piece of information, and outputting the fourth piece of information to the first apparatus.

20. The second apparatus according to claim 19, wherein the compartment system is configured to generate a new key, wherein the new key and the piece of information that is based at least on the fourth piece of information are output, in particular together, from the second apparatus to the first apparatus, wherein the first apparatus replaces the key with the new key based on this piece of information.

21. The second apparatus according to claim 13, wherein the memory and the program code are configured to cause the second apparatus to perform and/or control at least one of the following:
outputting the third piece of information to the first apparatus, wherein the third piece of information is associated with the compartment system; or
generating a fourth piece of information, wherein the fourth piece of information is associated with the third apparatus, and wherein, after obtaining the fourth piece of information by the first apparatus, at least a piece of information that is transmitted between the first apparatus and the second apparatus is based at least on the fourth piece of information, and outputting the fourth piece of information to the first apparatus; or
generating a fifth piece of information, and outputting the fifth piece of information to the first apparatus, wherein obtaining the fifth piece of information by the first apparatus is a further necessary condition for outputting the second piece of information by the first apparatus; or
obtaining a sixth piece of information from the first apparatus, wherein the sixth piece of information is based on the result of the authentication of the second apparatus, and wherein a positive result of the authentication is a necessary condition for outputting the fifth piece of information.

22. A third apparatus comprising at least one processor and at least one memory comprising program code, wherein the memory and the program code are configured to cause the third apparatus having the at least one processor to perform and/or control:
obtaining a third piece of information from a compartment system or generating a third piece of information; and
outputting the third piece of information to a second apparatus, wherein obtaining the third piece of information by the second apparatus is a necessary condition for outputting a first piece of information to a first apparatus by the second apparatus, wherein a positive result of the authentication of the second apparatus by the first apparatus based at least on the first piece of information is a necessary condition for outputting a second piece of information by the first apparatus, wherein the third apparatus or a user of the third apparatus can gain access to one or more compartments of a compartment system using the second piece of information.

23. The third apparatus according to claim 22, wherein the memory and the program code are configured to cause the third apparatus to perform and/or control:
obtaining the second piece of information from the second apparatus; and
outputting the second piece of information to the compartment system.

24. The third apparatus according to claim 23, wherein the second piece of information is encrypted with a key, wherein the key is stored in the compartment system, wherein the key is not known to the second and to the third apparatus.

25. The third apparatus according to claim 24, wherein the memory and the program code are configured to cause the third apparatus to perform and/or control:
obtaining, from the compartment system, a seventh piece of information that is generated by the compartment system and is encrypted with the key, wherein, after the first apparatus obtains the seventh piece of information, the first apparatus generates an eighth piece of information based at least on the decrypted seventh piece of information and outputs the eighth piece of information to the second apparatus; and
outputting the seventh piece of information to the second apparatus.

26. The third apparatus according to claim 24, wherein the key is generated by the compartment system and/or wherein the key in only temporarily valid.

27. The third apparatus according to claim 24, wherein the third piece of information contains at least the key.

28. A compartment system comprising at least one processor and at least one memory comprising program code, wherein the compartment system is in a system having a first apparatus, comprising at least one first processor and at least one first memory comprising a first program code, wherein the first memory and the first program code are configured to cause the first apparatus having the at least one first processor to perform and/or control:
obtaining a first piece of information from a second apparatus, wherein the first piece of information is associated with the second apparatus;
authenticating the second apparatus based on at least the first piece of information;
generating a second piece of information, wherein a third apparatus different from the second apparatus or a user of the third apparatus can gain access to one or more compartments of the compartment system using the second piece of information; and
outputting the second piece of information, wherein a positive result of the authentication of the second apparatus is a necessary condition for outputting the second piece of information,
wherein the second apparatus comprises at least one second processor and at least one second memory comprising a second program code, wherein the second memory and the second program code are configured to cause the second apparatus having the at least one second processor to perform and/or control:
obtaining a third piece of information from the third apparatus;
generating the first piece of information, wherein the first piece of information is associated with the second apparatus; and
outputting the first piece of information to the first apparatus in order to allow the first apparatus to authenticate the second apparatus based on at least the first piece of information, wherein a positive result of the authentication is a necessary condition for outputting the second piece of information from the first apparatus, wherein the third apparatus or a user of the third apparatus can gain access to the one or more compartments of the compartment system using the second piece of information, and wherein obtaining the third piece of information is a necessary condition for outputting the first piece of information, and
wherein the third apparatus comprises at least one third processor and at least one third memory comprising a third program code, wherein the third memory and the third program code are configured to cause the third apparatus having the at least one third processor to perform and/or control:
obtaining the third piece of information from a compartment system or generating the third piece of information; and
outputting the third piece of information to the second apparatus, wherein obtaining the third piece of information by the second apparatus is a necessary condition for outputting the first piece of information to the first apparatus by the second apparatus, wherein a positive result of the authentication of the second apparatus by the first apparatus based at least on the first piece of information is a necessary condition for outputting the second piece of information by the first apparatus, wherein the third apparatus or a user of the third apparatus can gain access to the one or more compartments of the compartment system using the second piece of information,
wherein the memory and the program code of the compartment system are configured to cause the compartment system having the at least one processor to perform and/or control:
obtaining the second piece of information; and
determining whether access to the one or more compartments of the compartment system can be granted based on the second piece of information.

29. The compartment system according to claim 28, wherein the second piece of information is obtained from the third apparatus.

30. The compartment system according to claim 28, wherein the memory and the program code are configured to cause the compartment system to perform and/or control:
generating the third piece of information; and
outputting the third piece of information to the third apparatus.

31. The compartment system according to claim 28, wherein the second piece of information is encrypted with a key, wherein the key is stored in the compartment system, wherein the key is not known to the second and to the third apparatus.

32. The compartment system according to claim 31, wherein the memory and the program code are configured to cause the compartment system to perform and/or control:
generating a seventh piece of information that is encrypted with the key, wherein, after the first apparatus obtains the seventh piece of information, the first apparatus generates an eighth piece of information based on the decrypted seventh piece of information and outputs the eighth piece of information to the second apparatus; and
outputting the seventh piece of information.

33. The compartment system according to claim 31, wherein the key is generated by the compartment system and/or wherein the key is only temporarily valid.

34. The compartment system according to claim 31, wherein the third piece of information contains at least the key and/or wherein the authentication of the second apparatus by the first apparatus is further based on the third piece of information.
